(19) United States
(12) Patent Application Publication
(10) Pub. No.: US 2015/0107444 A1
(43) Pub. Date: Apr. 23, 2015

(54) DIGITALLY CONTROLLED MUSICAL INSTRUMENT

(71) Applicant: Cornell Center for Technology, Enterprise & Commercialization, Ithaca, NY (US)

(72) Inventor: Pouria Pezeshkian, Edmond, OK (US)

(21) Appl. No.: 14/394,713

(22) PCT Filed: May 16, 2013
(86) PCT No.: PCT/US13/36849

§ 371 Date: Oct. 15, 2014

Related U.S. Application Data
(60) Provisional application No. 61/624,697, filed on Apr. 16, 2012.

(51) Int. Cl. G10H 1/34

(52) U.S. Cl. CPC G10H 1/34
USPC 84/645

(57) ABSTRACT

Digitized components are used with an electric musical instrument to save one or more component configurations into one or more presets thereby enabling a user to instantly select the saved component configurations for output. The user can select the saved component configurations using one or more buttons or a pick-up selector switch to instantly change pick-up, tone and volume. In addition, the electric musical instrument is able to produce sound in the event of a power loss.

### CROSS-REFERENCE TO RELATED APPLICATIONS

The application claims priority to U.S. Provisional Patent Application No. 61/624,697 filed Apr. 16, 2012, the disclosure of which is hereby incorporated by reference in its entirety.

### FIELD OF THE INVENTION

The invention relates generally to musical instruments. More specifically, the invention relates to digitized components to automatically control output of musical instruments including in the event of a power loss.

### BACKGROUND OF THE INVENTION

Musical instruments are devices that can produce sound. Most acoustic instruments have electric versions, otherwise known as electric instruments. An electric musical instrument is a musical instrument that can produce its sounds using electronics to convert acoustic waves to electric waves. Such an instrument sounds by outputting an electrical audio signal. Specifically, the electrical audio signal is amplified so that it will produce sound through a loudspeaker.

Various methods are currently available to change the sound produced by an electric instrument, such as through a user interface. A user interface such as effects pedals or component knobs are used to adjust the character of the sound including frequency response or pitch, and amplitude or loudness of the music produced.

Often times, a musician needs to have multiple component configurations during a performance in order to produce different sounds. For example, a musician playing an electric guitar may adjust the pick-up selector switch component, tone knob components, and volume knob component to achieve a desired sound output. The musician may need to adjust the pick-up selector switch and knobs many times during a performance. As an example, a particular song may warrant the use of a variety of component configurations, and to quickly switch the character of the sound during a performance—by adjusting the pick-up selector switch to choose a desired pick-up and adjust the tone knobs and volume knobs accordingly—is cumbersome. There are currently no devices on the market that enable a quick sound change aside from foot pedals.

In addition, there is a desire for an electric instrument that is able to produce sound in the event of a power loss.

In view of the foregoing, there is a need for a musical instrument that enables a musician to instantly change component configurations as well as to permit the instrument to produce sound in the event of a power loss. The invention satisfies this need.

### SUMMARY OF THE INVENTION

The invention is discussed in reference to an electric stringed musical instrument for exemplary purposes only. It is contemplated that the invention is applicable to any musical instrument that produces its sounds using electronics including, for example, electric basses, electric violins, electric cellos, electric banjos, electric mandolins, and other electric instruments.

The invention uses digital electronics to create a smarter and friendlier musical instrument. One or more presets are provided to save the character of sound, which enables a musician to instantly change between different sounds while playing the instrument, for example, with the push of a button or touch of an icon on a touch screen/surface. Each preset button allows the user to change any of the user interface components including volume, first tone, second tone, pick-up one, pick-up two, pick-up three (additional pick-ups may be included depending on the total number of pick-ups provided by the instrument). The settings or values for each of the components are uploaded and saved to each preset in order to produce the desired sound when the preset is selected. The preset may be selected through a user interface, for example, one or more buttons or pick-up selector switch.

“Character” of the sound refers to the frequency response or pitch and loudness or amplitude of the sound produced. Specifically, character of the electrical signal of the sound produced is determined by the configuration of the components, or component configuration. “Component configuration” refers to the value of the components of the user interface. One or more pick-ups—“bass/neck”, “midrange/middle”, “treble/bridge”—is selected using the pick-up selector switch, the value of pitch or frequency response is determined by adjusting the tone knob or knobs, and the value of amplitude or loudness is determined by adjusting the volume knob or knobs. Thus, the pick-up selected by the position of the pick-up selector switch, position of each tone knob, and position of each volume knob determines the frequency response or pitch and amplitude or loudness to give the sound its character. According to the invention, a component configuration may include values for one or more user interface components to determine character of the sound output. For example, a first component configuration may consist of a combination of a first pick-up, a first tone value for each tone knob and a first volume value; a second component configuration may consist of a combination of a second tone value for each tone knob and a second volume value; and a third component configuration may consist of only a third tone value for one tone knob.

According to the invention, digital electronics either replace or are integrated along with traditional analog components. For example, the tone knobs and volume knob are replaced or integrated along with its digital counterpart, specifically a rotary encoder integrated with the microcontroller to control the programmable digital potentiometer circuitry—which can replicate the functionality analog potentiometer of the guitar. The pick-up selector switch can be replaced or included with its digital counterpart that includes a multiplexer to communicate with the microcontroller unit. In embodiments in which the digital electronics are integrated with analog components, a selector element is provided to enable the user or the instrument to choose between modes of operation—a first mode that uses the digital electronics to control the analog components and a second mode that uses the traditional analog components.

Since the invention digitally-controls analog components, the electrical audio signal path passes through the circuitry in analog form, with minimal effects on the sound produced. Thus, the electrical audio signal is never converted to a digital signal. However, it is contemplated that certain embodiments of the invention may convert the electrical audio signal to a digital signal.

One or more presets are used to upload and save the character of the sound produced using digital electronics. According to the invention, different sounds are saved into presets thereby enabling the user to instantly change the character of the sound output—pick-up, tone and volume—with the selection of a button or position of the pick-up selector switch.

In one embodiment, the character of the sound is uploaded and automatically saved in selectable presets. More specifically, the component configurations in this embodiment include a combination of tone, volume, and pick-up. The settings for each component are saved and selected/uploaded using buttons. The saving can occur automatically anytime a change is made to the configuration.

With this embodiment, the presets may be controlled in a number of ways. For example, two buttons can be used—up/down or forward/reverse. The buttons are used to scroll through the presets. The component configuration—volume knob position, tone knob position, and switch position—is saved to a preset by pushing a button, or pushing multiple buttons simultaneously, or automatically saved when there is a change in the component configuration. An upload can occur at the push of either a up/forward or back/reverse button. Therefore, any change to the value of volume knob position, tone knob position, and pick-up selector switch position is automatically saved to the selected preset. As another example, one or more buttons may also be used to scroll through the presets sequentially and to upload and automatically save to the preset such as by pressing and holding the button for an extended period of time, i.e., three seconds. As another example, buttons may be used in a one-to-one mapping arrangement. Therefore, each preset corresponds to its own button. Any number of buttons may be used depending on the number of individual component configurations desired. The user can select a component configuration by selecting the appropriate button. For example, a musical instrument with eight buttons has eight separate and distinct presets associated with each button.

In another embodiment, the character of the sound is automatically saved in presets associated with each position of the pick-up selector switch. More specifically, the component configurations in this embodiment include a combination of tone and volume. With this embodiment, the presets may be controlled in a number of ways. The values or settings for each of the tone knob components and the volume knob component are saved and selected using the pick-up selector switch. For example, a first pick-up selector switch position corresponds to the first pick-up along with a preset tone and preset volume. With this embodiment, the component configuration—volume knob position, tone knobs positions—is uploaded to a preset by changing the position of the knobs, i.e., every time the user adjusts any of the tone-knobs and/or volume knob. After the component configuration is uploaded it is automatically saved. Therefore, any change to the position of the volume knob or either tone knobs is automatically saved to the preset as selected by the position of the pick-up selector switch. Component configurations are selected to produce the desired sound by the user choosing the position of the pick-up selector switch that corresponds to the desired preset. With this embodiment, since there are no added buttons, the maximum number of presets is determined by the number of positions associated with the pick-up selector switch of the instrument. For example, a standard guitar typically has five positions thereby providing five presets.

A mechanical embodiment is also contemplated that requires gears and a set of analog potentiometers. The set of analog potentiometers includes, for example, a variable X representing the number of switch positions (i.e., five) and a variable Y representing the total number of tone and volume knobs (i.e., three) Therefore, an instrument with five switch positions and three knobs would have a total of 3×5=15 potentiometers (this assumes that all tone knobs are active at every switch position, which is not the case with instruments such as the Stratocaster). The basic idea here is that the out of the 15 potentiometers, only three are activated at a time. They are mechanically activated when the user actuates the switch. This can be done using gears and moving the gears or the potentiometers in place. The term mechanically activated means, that the rotation of the tone/volume knob will be mechanically transmitted to one of the five potentiometers. For example, if the pick-up selector switch is in position 3, the knob turned will turn only the 3^{rd} potentiometer. The switch clicks into place as do the potentiometer. Only 1 of the 5 potentiometers for each knob may be active at once by moving either the potentiometers to the new position, or by moving the electrical traces under the potentiometers, as well as the gears to move the correct potentiometer.

Certain embodiments of the invention may further include an interface, such as a Graphical User Interface (“GUI”), to communicate the information regarding the preset. The GUI may be a Liquid Crystal Display (“LCD”), illuminated buttons, a touch screen, or any combination thereof. For example, volume and tone information may appear on the LCD as progress bars, for example, by filling in pixels from left to right in the same space of three LCD characters. By using progress bars, it is easier for a user to see the settings at a glance, and it also maintains a more analog feel to the guitar controls. However, any indicator may be used such as numbers. At all times, the LCD displays all of the settings for the current preset.

In embodiments in which the digital electronics are included along with the analog components, the electric instrument is able to produce sound in the event of a power loss. When there is power, the output signal comes from the “digitally controlled” analog side, which has capabilities to upload component configurations and save presets. When power is low or fails to exist, the instrument changes back to the original analog controlled components. However, the digitally controlled analog side loses its capability to upload component configurations and save presets, but the instrument maintains its original functionality.

Touch pads, touch-turn wheel, or individual pick-up control can be used as an alternative to digital electronics. As an example, individual pick-up control can be accomplished by placing touch pads on the surface of the instrument next to each pick-up. A user places his or her finger on the touch pad corresponding to the desired pick-up and moves it to adjust the signal level of the pick-up. In this embodiment, pick-ups may be turned on individually and independently.

The invention and its attributes and advantages may be further understood and appreciated with reference to the detailed description below of one contemplated embodiment, taken in conjunction with the accompanying drawings.

### DESCRIPTION OF THE DRAWINGS

FIG. 1 shows a front view of an electric guitar.

FIG. 2 shows a schematic diagram of an exemplary electric-guitar circuit.

FIG. 3 illustrates a portion of a block diagram of the digital electronics integrated with traditional analog components according to an embodiment of the invention.

FIG. 4 illustrates a portion of a block diagram according to the embodiment of the invention that uploads and automatically saves component configurations in selectable presets.

FIG. 5 illustrates a portion of a block diagram according to the embodiment of the invention that uploads and automatically saves component configurations in selectable presets.

FIG. 6 illustrates a portion of a block diagram according to the embodiment of the invention that uploads and automatically saves component configurations in preset associated with each position of the pick-up selector switch.

FIG. 7 illustrates a schematic diagram according to the embodiment of the invention that uploads and automatically saves component configurations in preset associated with each position of the pick-up selector switch.

FIG. 8 illustrates a perspective view of an integrated rotary encoder and potentiometer to enable an electric instrument to produce sound in the event of a power loss according to one embodiment of the invention.

### DETAILED DESCRIPTION OF THE INVENTION

For clarity, the digital control components are described below with respect to an electric guitar. However, the digital control components can similarly be provided with other electric instruments, including electric basses, electric violins, electric banjos, electric mandolins, and other electric instruments.

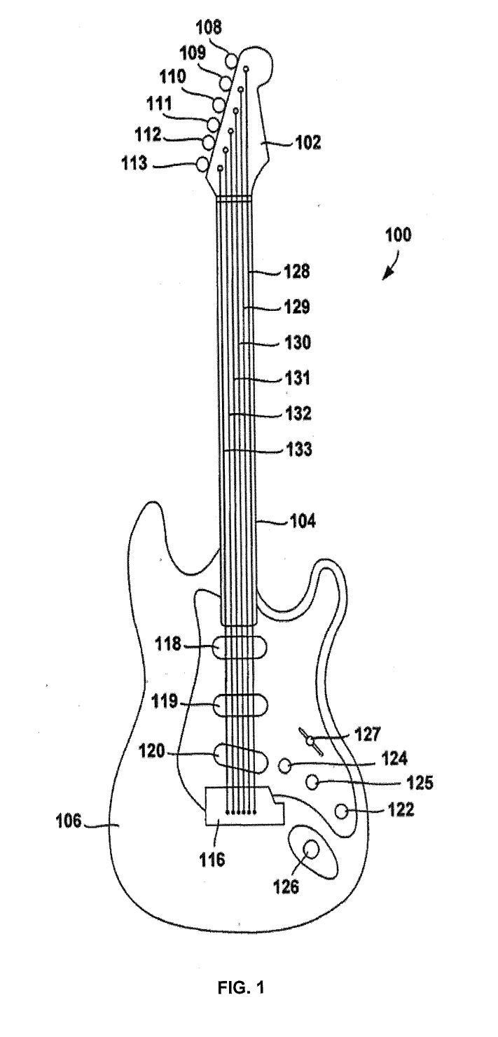

FIG. 1 shows a front view of an electric guitar. An electric guitar 100 includes a headstock 102, a neck 104, and a body 106. The headstock 102 contains six tuning pegs 108, 109, 110, 111, 112, 113. The body 106 contains a bridge 116, three pick-ups 118, 119, 120, a volume knob 122, two tone knobs 124, 125, an output jack 126, and a pick-up selector switch 127. Six strings 128, 129, 130, 131, 132, 133 extend from the bridge 116 to the six tuning pegs 108, 109, 110, 111, 112, 113, respectively. Guitar strings are typically made from a metal based or nylon based material.

Although the electric guitar 100 shown in FIG. 1 includes three pick-ups, one volume knob, and two tone knobs, it should be noted that different types of electric guitars may have a different number of pick-ups, volume knobs, tone knobs, and other features. As an example, an electric guitar may have four pick-ups, a separate volume knob for each pick-up, or one tone knob.

When a user plays the electric guitar 100, the user creates a vibration along one or more of the strings 128, 129, 130, 131, 132, 133 by plucking, raking, picking, hammering, tapping, slapping, or strumming (“playing”) one or more of the strings 128, 129, 130, 131, 132, 133 with a first hand while pressing a number of the played strings against the neck 104 at various locations with a second hand. The location along the neck 104 of the second hand pressing down on a given played string determines the frequency of the vibrations produced by that string. Additionally, the volume and the timbre of the vibration may be influenced by adjusting the volume knob 122 and the tone knobs 124, 125, respectively. The volume knob 122 and the tone knobs 124, 125 function by adjusting variable resistances within the instrument to change volume and tone.

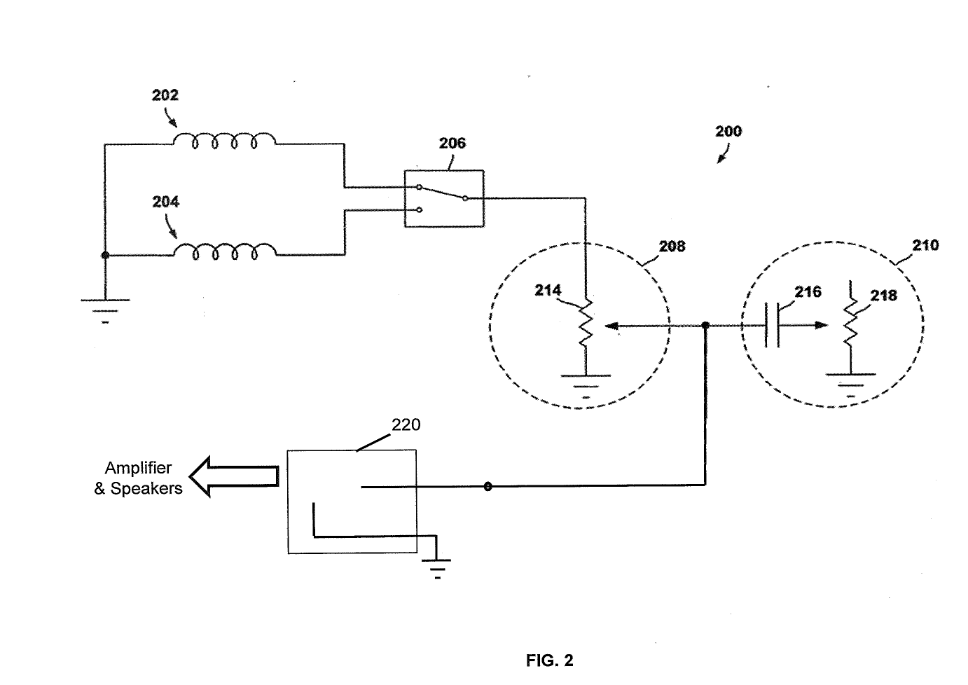

The six strings 128, 129, 130, 131, 132, 133 pass over the three pick-ups 118, 119, 120. Each pick-up 118, 119, 120 contains a number of magnets wrapped in wire. The pick-up selector switch 127 selects which pick-up o combination of pick-ups to covert the sound signal. Specifically, the pick-up selector switch 127 electromechanically selects a pick-up or mixes and connects different pick-ups. Specifically, the vibrations of an overlying metallic string 128, 129, 130, 131, 132, 133 cause a signal to be induced in one or more of the wires wrapped around one or more of the magnets. The signal passes along an electric- guitar circuit (see FIG. 2) from one or more of the pick-ups 118, 119, 120 to the output jack 126. A cable (not shown) connects the guitar 100 from the output jack 126 to other devices, such as an amplifier.

FIG. 2 shows a schematic diagram of an exemplary electric-guitar circuit. An electric-guitar circuit 200 includes pick-up coils depending on the number of pick-ups. As shown in FIG. 2, the circuit 200 includes a first pick-up coil 202 and a second pick-up coil 204. A pick-up selector 206 allows a user to select to receive a signal from one of the available pick-ups. The volume adjuster 208 and the tone adjuster 210 are shown as dashed circles surrounding various associated electrical components. The volume adjuster 208 includes one or more adjustable volume resistors 214. The tone adjuster 210 includes a band-pass filter comprised of one or more capacitors 216 and one or more adjustable tone resistors 218. The volume adjuster 208 and the tone adjuster 210 are user-controlled by knobs interconnected to one or more potentiometers. The output jack 220 connects an instrument cable (not shown) to the electric-guitar circuit 200 and another device, such as an amplifier.

An induced signal is created in the selected pick-up coil 202, 204 by a vibrating string. The induced signal transmits through the volume adjuster 208 (“volume knob”) and the tone adjuster 210 (“tone knob”) before reaching the output jack 220. A user can use the volume knob 208 and/or the tone knob 210 to adjust the character of the sound.

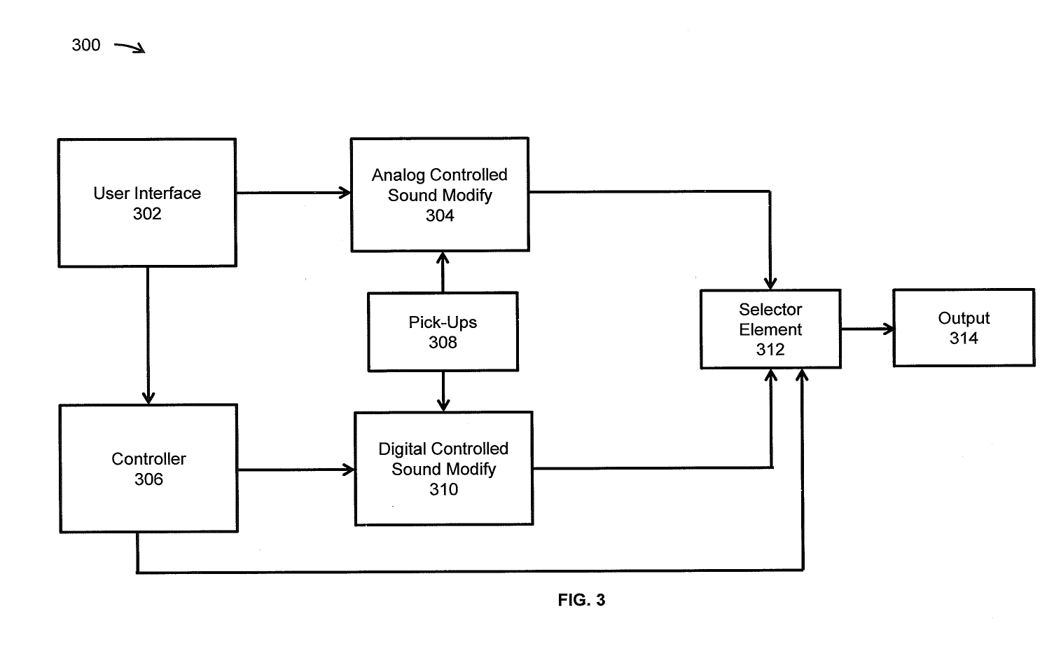

FIG. 3 illustrates a portion of a block diagram of the digital electronics integrated with traditional analog components according to an embodiment of the invention. A user interface 302 includes all components that are used to modify sound—pick-up selector switch component, tone knob components, and volume knob component. Using digital electronics, components of the user interface 302 communicate with a digital controller 306 to digitally modify the sound 310. Otherwise, the user interface 302 modifies sound 304 according to traditional analog technology. The selected pick-ups 308 modify sound according to analog technology 304 or modify sound according to digital technology 310. A selector element 312 which functions similar to an single-pole, double-throw (“SPDT”) switch is used to select between analog controlled sound modify 304 and digital controlled sound modify 310 before the sound is output 314. Alternatively, two selector elements may be used to control the signal path, which may be preferred for noise reduction, etc. The selector element 312 may be a digitally controlled analog switch that latches and does not require power to keep latched (such as a latch relay). The controller 306 controls the selector element 312.

FIG. 4 illustrates a portion of a block diagram according to the embodiment of the invention that uploads and automatically saves component configurations in selectable presets. Controller 402, which may be a microcontroller unit (“MCU”), includes a single chip that contains a processor, RAM, ROM, clock and I/O control unit. The controller 402 communicates with the pick-up selector switch 404, Graphical User Interface (“GUI”) 406, digital controlled potentiometers 408, selector element 410, rotary encoders/push buttons 412 and an analog multiplexer (“MUX”) 414.

In order to produce sound in the event of power loss, the original instrument circuitry will be integrated with the digitally controlled circuitry. Moreover, the original circuitry is one signal path whereas the digitally controlled circuitry is another signal path. The original instrument circuitry does not need additional power whereas the digitally controlled circuitry does. The controller 402 can sense if the power is low, or there is a power loss (brown out). At that instant, before the power shuts off, the controller 402 controls the selector element 410 to select the original “analog” instrument circuitry. Since it is contemplated that the selector element 410 is a latch type device, it does not require power to remain in a switch-state. When there is no power, the instrument is not able to save and upload, however since the selector element 410 switches to the original analog circuitry that does not require power, the instrument remains capable of producing sound, and maintaining certain original functionality, such as tone/volume adjusting.

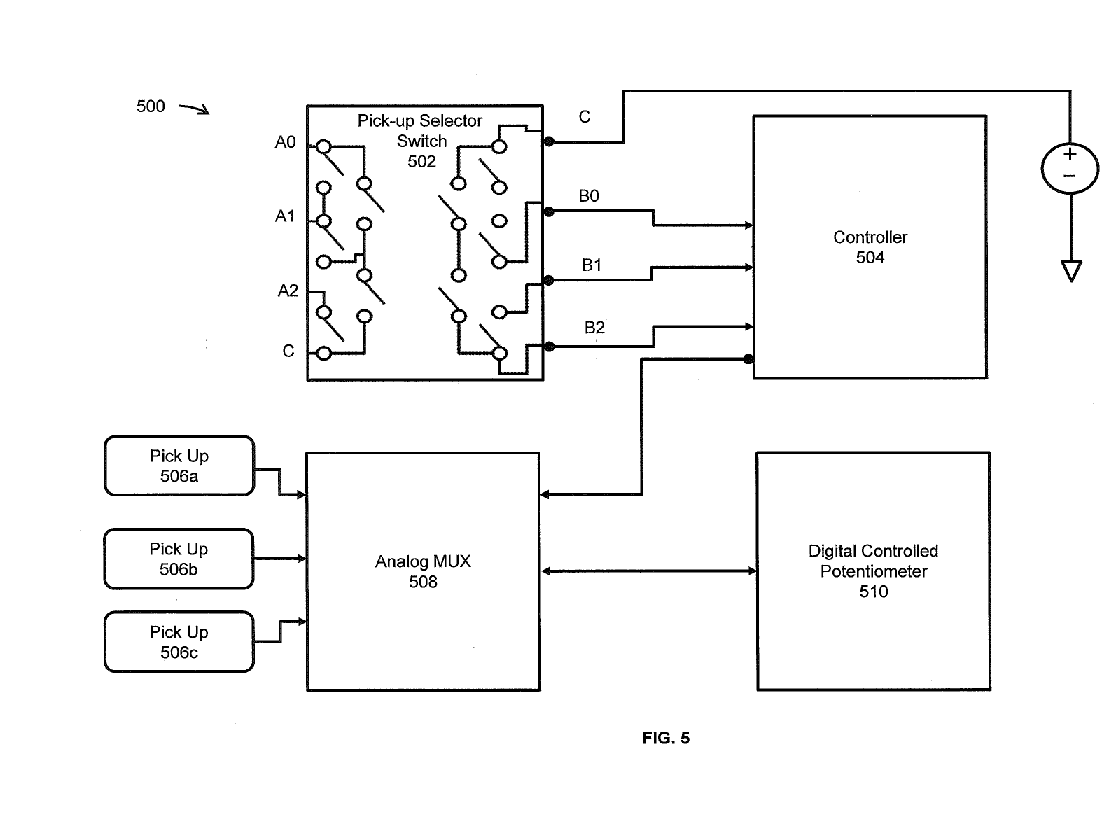

FIG. 5 illustrates a portion of a block diagram according to the embodiment of the invention that uploads and automatically saves component configurations in selectable presets. Specifically, FIG. 5 illustrates the details of the pick-up selector switch 502, and controller 504 that senses the position of the pick-up selector switch in order to control the analog MUX 508. Thus, the functionality of the pick-up selector switch 502 is replaced with the analog MUX 508 to select which pick-up 506a, 506b, 506c is selected. The pick-ups 506a, 506b, 506c are connected to the analog MUX 508 which selects between pick-ups 506a, 506b, 506c, then electrically coupled with the digital potentiometers and analog capacitors to mimic the functionality of a standard electric guitar. The digital controlled potentiometers 510 control volume and tone. The digital controlled potentiometers 510 are controlled by controller 504.

The pick-up selector switch 502 can be sensed in a variety of ways. One way this can be done is by disconnecting all ports from the pick-up selector switch 502, connecting a voltage to the common port (C) and connecting the pins (B0-B3) to the controller 504. The controller 504 can then sense voltage from common port (C). The controller 504 uses this information to control the (digitally controlled) analog MUX 508 thereby replacing the switch circuitry of the standard electric guitar. The remaining circuitry is the same—instead of using analog potentiometers controlled by mechanical rotation through the user interface, the analog potentiometers are controlled by the controller 504. The controller 504 senses mechanical rotation using rotary encoders described more fully below.

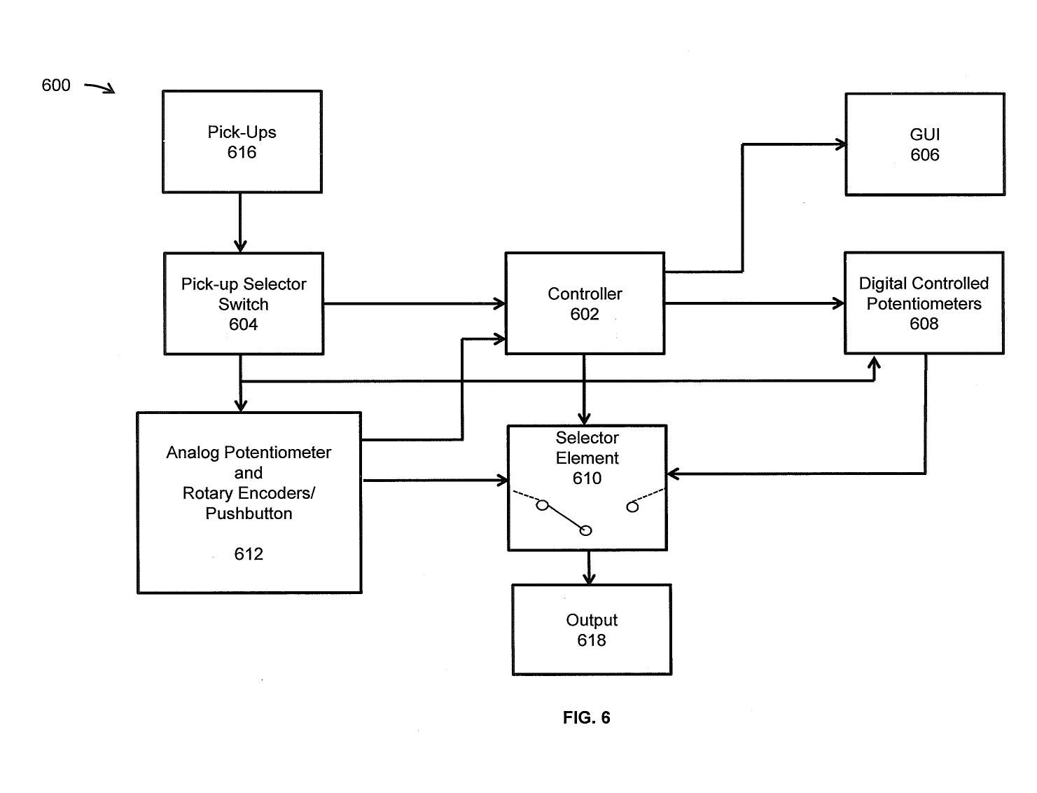

FIG. 6 illustrates a portion of a block diagram according to the embodiment of the invention that uploads and automatically saves component configurations in preset associated with each position of the pick-up selector switch. Controller 602 602 includes a single chip that contains a processor, RAM, ROM, clock and I/O control unit such as a microcontroller unit. The controller 602 communicates with the pick-up selector switch 604, Graphical User Interface (“GUI”) 606, digital controlled potentiometers 608, selector element 610, and an analog potentiometer and rotary encoders 612. In this optimized configuration, the pick-ups 616 are connected as they would be in traditional guitar. The pick-ups 616 are selected by the pick-up selector switch 604, and then split to the analog potentiometer 612 path and digital controlled potentiometers 608 path. As the user turns the integrated analog potentiometer and rotary encoder pushbuttons 612, the controller 602 decodes the rotary encoder data and determines a value for the digitally controlled potentiometers 608, and determines the particular digital potentiometers 608 to modify. Both paths are electrically modified with user input, but only one path is connected to the output 618 at a time. When there is power, the digitally controlled path is the default path. In the event of a power loss, the selector element 610 is used to select by the controller 602 the analog controlled path—the path that does not require power.

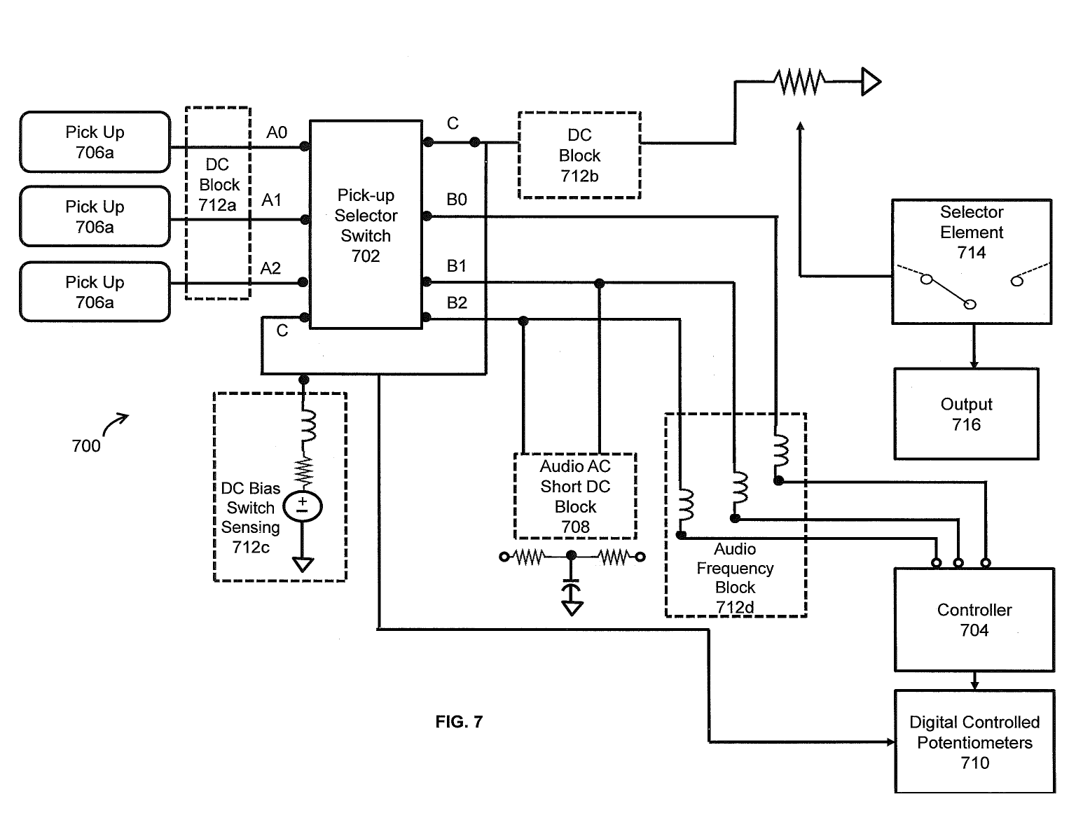

FIG. 7 illustrates a schematic diagram according to the embodiment of the invention that uploads and automatically saves component configurations in presets associated with each position of the pick-up selector switch 702. In this embodiment, the pick-ups 706a, 706b, 706c remain connected to pick-up selector switch 702, but the signal path is modified to filter digital signals. Specifically, the signal path is split between the traditional analog components and the digital controlled analog system. The controller 704 controls the digital potentiometers 710 depending on the position of the pick-up selector switch 702. The digital controlled potentiometers 710 are coupled with a capacitor similar to the circuitry of the traditional analog potentiometer and capacitor. A selector element 714 is provided to enable selection between modes of operation—a first mode that uses the digital electronics and a second mode that uses the traditional analog components—before the sound is output 716.

The DC block 712a, blocks DC voltage from the pick-ups 706a, 706b, 706c. The DC Bias—Switch Sensing 712c, is comprised of a DC voltage source, resistor for current control, and inductor for filtering. It is used as a mechanism for the controller 704 to sense the positions of the pick-up selector switch 702. The DC bias on the pin/port (C) shorts to a combination of the B0, B1, B2 pin/port, and is decoded by the controller 704 to determine the position of the switch. The DC voltage block 712c also applies some filtering, such as audio-frequency block 712d using an inductor so that the audio signal from the selected pick-ups is unaffected by the DC source. The DC block 712b performs the same function as the DC block 712a, and blocks any DC bias to the output. The audio AC short DC block 708 also blocks DC voltage from the analog potentiometers by providing a large electrical resistance against the current from the DC bias voltage 712c; however it allows the audio-frequency signals to flow in order to allow the audio frequency to be manipulated by the resistor-capacitor circuit. In combination of these components, the original guitar circuitry is minimally impacted and the functionality of digital save/upload is economically integrated.

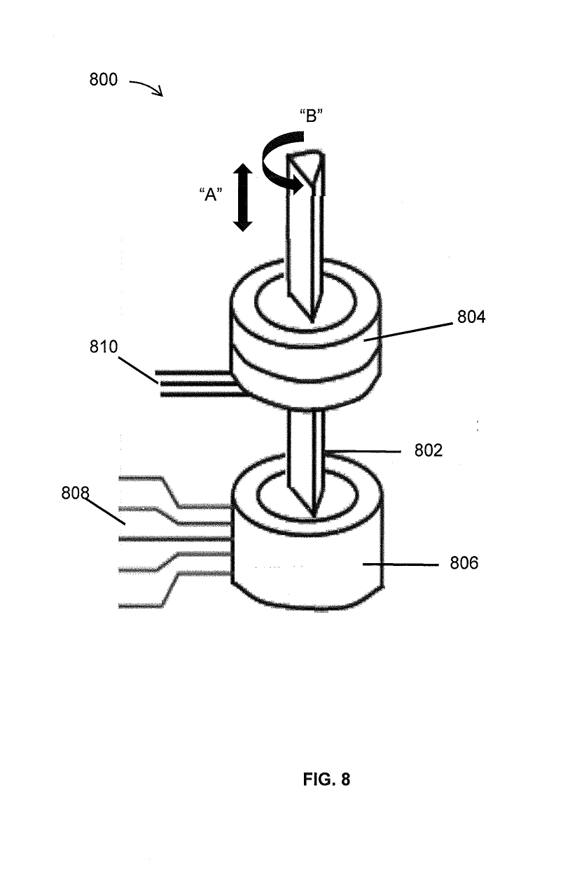

FIG. 8 illustrates a perspective view of an integrated rotary encoder and potentiometer to enable an electric instrument to produce sound in the event of a power loss according to one embodiment of the invention. When there is power, the output signal comes from the “digitally controlled” analog side, which has capabilities to upload component configurations and save presets. When power is low or fails to exist, the instrument changes back to the original analog controlled components. However, the digitally controlled analog side loses its capability to upload component configurations and save presets, but the instrument maintains its original functionality.

A no-power functional device 800 is shown in FIG. 8 that includes an analog potentiometer 804 and a rotary encoder 806 positioned on an extended shaft 802 that rotates in the direction of “B” as well as longitudinally translates in the direction of “A”. Since analog potentiometers have a finite rotation and digital encoders have infinite rotation, the analog potentiometer will lock at minimum and maximum ends inhibiting the free rotation of the digital rotary encoder. Therefore, the device 800 as shown in FIG. 8 mechanically integrates the analog potentiometer 804 and digital rotary encoder 806 so that the shaft 802 can rotate freely without having the potentiometer 804 interfere with the rotation of the shaft 802.

In one embodiment, the potentiometer 804 saturates in value when it reaches a maximum or minimum value, but it does not inhibit rotation in that it spins continuously.

In another embodiment, a torque transmitter is included that allows the rotation torque to be transmitted to the shaft 802, yet does not affect the analog potentiometers' shaft. Specifically, a torque transmitter facilitates the transmission of rotation to different segments. For example, it can stop rotating the finite segment while continuously rotating the infinite segment. Specifically, the torque transmitter moves the finite analog potentiometer until the potentiometer reaches is finite limits while the shaft 802 can continue to turn outside of the finite limits.

It is also contemplated that a motorized potentiometer may be used that integrates a servo-motor with an analog potentiometer. The servo-motor senses position and can further move to any position. Therefore, when the shaft rotates, the servo-motor also rotates and communicates to the controller its position. Likewise, the controller can control the servo-motor to move to any position

Digital rotation data 808 and analog potentiometer data 810 is communicated to the controller (see FIG. 4 and FIG. 6) in order for the instrument to produce sound output in the event of a power loss. Rotation data can be extrapolated via hardware or software. For example, for continuous rotary encoders, quadrature type signal processing is used in the industry. Quadrature encoders output two pulses that are 90 degrees out of phase, with one pulse leading the other depending on the direction of rotation. Whether implemented in hardware or software, rotation can be decoded based on which pulse leads the other. Rotary encoders require power and a biasing circuit to enable sensing on the two outputs. Rotary encoders come with push button functionality as an option. There are many types of rotary encoders: mechanical/optical/magnetic/etc. The number of pulses can give information about the number of turns, which can extrapolate position. With an additional timing circuit, the controller can extrapolate velocity and acceleration. The analog potentiometer is the original analog potentiometer, with the difference that it is integrated mechanically with the digital rotary encoder 806. Specifically, since the electrical audio signal path passes through the circuitry in analog form, the electrical audio signal is never converted to a digital signal. Either a manual switch or automatic switch can be provided that directs the audio signal either through the analog signal path or digitally controlled analog signal path. In the event of a power loss, the electrical audio signal can take the analog signal path in order for the instrument to maintain its ability to produce sound.

The described embodiments are to be considered in all respects only as illustrative and not restrictive, and the scope of the invention is not limited to the foregoing description. Those of skill in the art may recognize changes, substitutions, adaptations and other modifications that may nonetheless come within the scope of the invention and range of the invention.

1. An electric music instrument, comprising:
a preset;
a user interface including one or more components configured to select a frequency response setting and an amplitude setting for sound output;
a controller configured to save the frequency response setting and the amplitude setting to the preset;
a digital controlled potentiometer configured to apply the frequency response setting and the amplitude setting to the sound output when the preset is selected.

2. The electric music instrument of claim 1 further comprising a selector element configured to select between an analog controlled sound output and a digitally controlled sound output.

3. The electric music instrument of claim 1 wherein the preset is associated with a button of the user interface.

4. The electric music instrument of claim 1 wherein the preset is associated with a pick-up selector switch.

5. An electric music instrument, comprising:
an extended shaft;
a digital controlled analog potentiometer to produce an analog potentiometer value and positioned on the extended shaft; and
a digital rotary encoder configured to produce digital rotary encoder output and positioned on the extended shaft,
wherein the digital controlled analog potentiometer and the digital rotary encoder are integrated such that the electric musical instrument is configured to produce sound output in the event of a power loss.

6. The music instrument of claim 5 wherein the digital controlled analog potentiometer further comprises a torque transmitter.
